(19) United States
(12) Patent Application Publication
(10) Pub. No.: US 2020/0063770 A1
(43) Pub. Date: Feb. 27, 2020

(54) Device for Holding a Directly Controlled Valve in a Valve Housing, in a Channel Plate or in a Transmission Housing

(71) Applicant: ZF Friedrichshafen AG, Friedrichshafen (DE)

(72) Inventor: Marcel Gutzeit, Meckenbeuren (DE)

(21) Appl. No.: 16/550,702

(22) Filed: Aug. 26, 2019

(30) Foreign Application Priority Data
Aug. 27, 2018 (DE) 10 2018 214 442.7

(51) Int. Cl. F16B 2/24; F16H 61/00

(52) U.S. Cl. CPC F16B 2/245; F16H 61/0009

(57) ABSTRACT

A device for fixing a directly controlled valve (1) acting as an actuator in a valve housing (2), in a duct plate, or in a transmission housing, the device being fixed to the valve housing (2), the duct plate, or the transmission housing by fixing elements (7), the device including a fixing plate (3) having a spring-loaded length (L). The spring-loaded length (L) is adjustable independently of a distance of the fixing elements (7) from a central axis (4) of the actuator.

### FIELD OF THE INVENTION

The present invention relates generally to a device for holding a directly controlled valve in a valve housing, in a channel plate, or in a transmission housing.

### BACKGROUND

Directly controlled valves or actuators are utilized, for example, in hydraulic control units of automatic transmissions for motor vehicles. The hydraulic control unit generally includes multiple actuators or actuating elements, which are arranged in a valve housing and are electrically actuated.

DE 10 2009 046 618 A1 of the applicant describes a device for the mechanical fixation and electrical connection of at least one actuating element, which includes first electrical contacts, in a housing, wherein second electrical contacts are configured to connect with the first electrical contacts. In this case, it is provided that the second electrical contacts are arranged on a connection element which is pluggable into the housing and, due to the plug-in movement, simultaneously brings about the electrical connection and a form-locking mounting of the at least one actuating element.

The problem addressed by the present invention is that of providing a device for fixing or holding a directly controlled valve or actuator in a valve housing, in a channel plate, or in a transmission housing.

### SUMMARY OF THE INVENTION

Accordingly, a device is provided for holding or fixing a directly controlled valve or actuator in a valve housing, in a duct or channel plate, or in a transmission housing. The device is a fixing plate, where a spring-loaded length of the fixing plate is adjustable independently of the distance of the fixing elements of the fixing plate to a central axis of the actuator.

The fixing plate is bent essentially in a U-shape and has a first leg and a second leg, wherein the first leg of the fixing plate is shorter than the second leg. In a mounted state, the first leg is fixed on the valve housing, on a duct plate, or on a transmission housing. The second leg includes two fingers arranged in parallel to one another, and, with the exception of the free ends of the fingers, the second leg extends spaced apart from the valve housing, from the duct plate, or from the transmission housing and from the actuator in the mounted state. In the mounted state, the free ends of the fingers, which are bent towards the actuator, introduce a clamping force onto the actuator. The spring-loaded length of the fixing plate is determined by a length of the second leg between the apex of the fixing plate and the free ends of the fingers.

The fixing plate is formed as a one-piece sheet-metal component produced using sheet-metal forming, which is, advantageously, simple and cost-effective.

The fixation of the first leg of the fixing plate on the valve housing, on a duct plate, or on a transmission housing preferably takes place using bolts with a minimal bolt spacing between the central axis of the actuator and the bolts. The first leg of the fixing plate has corresponding bolt holes. Due to the fact that the bolted connection takes place close to the actuator inserted into the valve housing, into the duct plate, or into the transmission housing, material on the valve housing, on the transmission housing, or on the duct plate, as well as installation space are advantageously saved.

The clamping forces acting on the actuator via the fingers increase with an increased spring-loaded length, namely an increase in the length of the second leg between the apex of the fixing plate and the free end of the fingers. So, different clamping forces are implementable with the aid of different lengths of the legs of the fixing plate resulting from a displacement of the apex of the fixing plate perpendicularly to the central axis of the actuator, without changing the position of the actuator or the fixation of the fixing plate. Given the same clamping forces in each case, the fixing plate is subjected to lower stresses in the case of longer spring-loaded lengths than in the case of shorter spring-loaded lengths, and so the loads on the fixing plate are reduced.

In order to increase the clamping force given the same length of the fingers, the free ends of the fingers can meet the actuator at a greater angle, such as an angle up to 90° (in this case, the free ends of the fingers extend perpendicularly to the surface of the actuator), and so, due to the combination of a longer spring-loaded length and a greater angle, a larger clamping force is achievable for the same stress or a lower stress in the component.

In the fixing plate configurations known from the prior art, the spring-loaded length is determined by the distance of the bolts, which are utilized for the bolted connection of the fixing plate to the valve housing, to the central axis of the actuator.

According to the invention, in the case of hydraulic control units in which multiple directly controlled valves acting as actuators are to be fixed in adjacent valve housings or duct plates in each case, a common fixing plate assembly having multiple individual fixing plates in accordance with the invention is utilized, wherein a bolt hole is provided between the first legs of adjacent fixing plates of the multiple individual fixing plates of the common fixing plate assembly for the purpose of establishing a bolted connection to the valve housing.

### BRIEF DESCRIPTION OF THE DRAWINGS

The invention is explained in greater detail in the following, by way of example, with reference to the attached figures. Identical reference numbers mark identical components. In the figures, the following is shown:

FIG. 1 shows a section view of a directly controlled valve, which acts as an actuator and is fixed with the aid of a device according to the invention in a valve housing;

FIG. 2 shows a perspective view of a hydraulic control unit in which multiple directly controlled valves acting as actuators are fixed in a valve housing by a common fixing plate assembly, the common fixing plate assembly having multiple individual fixing plates designed according to the invention; and

FIG. 3 shows a top view of a common fixing plate assembly for fixing multiple actuators in a valve housing of a hydraulic control unit, the common fixing plate assembly having multiple fixing plates designed according to the invention.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

According to the invention and with reference to attached figures, a device is provided for fixing or holding a directly controlled valve 1, which acts as an actuator, in a valve housing 2. The fixing device is a fixing plate 3, where a spring-loaded length L of the fixing plate 3 is adjustable independently of a distance of fixing elements 7 of the fixing plate 3 from a central axis 4 of the actuator 1.

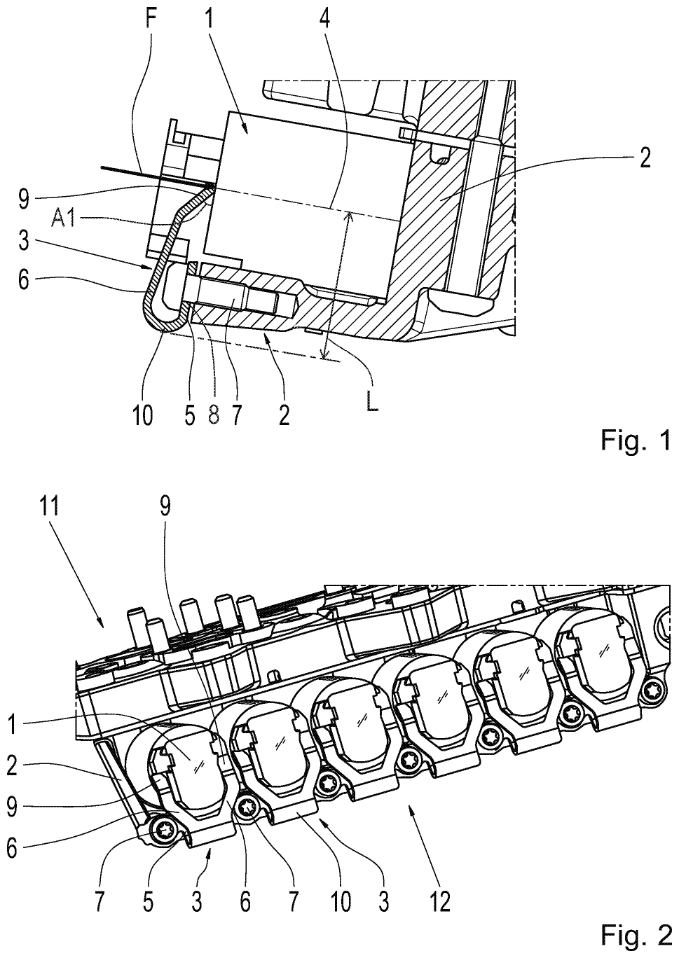

In the example shown in FIG. 1, the fixing plate 3 is bent essentially in a U-shape and has a first leg 5 and a second leg 6, wherein the first leg 5 is shorter than the second leg 6. In the mounted state, the first leg 5 is fixed on the valve housing 2 via bolts 7 acting as the fixing elements. The first leg 5 has bolt holes 8 for receiving the bolts 7. Due to the bolted connection, the fixing plate 3 is depressed onto the face of the valve housing 2, whereby a clamping force is introduced by the fixing plate 3 onto the actuator 1.

The second leg 6 has two fingers 9 as shown in FIG. 2, which are arranged in parallel to one another. As shown in FIG. 1, with the exception of free ends of the fingers 9, the second leg 6 extends spaced apart from the valve housing 2 and from the actuator 1 in the mounted state. In the mounted state, the free ends of the fingers 9, which are bent in the direction of the actuator 1, introduce a clamping force onto the actuator 1, which is indicated in FIG. 1 by the arrow F. The spring-loaded length L of the fixing plate 3 is defined by a length of the second leg 6 between an apex 10 of the fixing plate 3 and the free ends of the fingers 9.

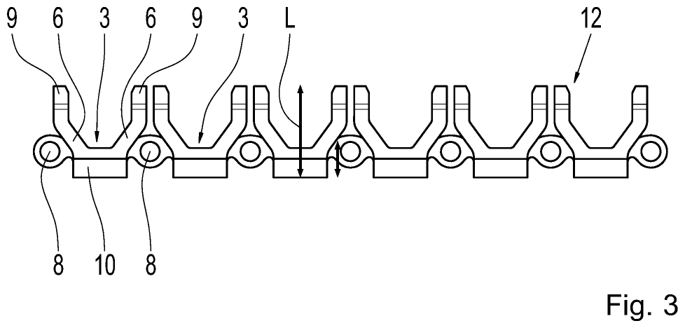

The fixing plate 3 according to the invention is utilized in hydraulic control units 11 for fixing multiple actuators 1 in a valve housing 2. In this case, a common fixing plate assembly 12 including multiple fixing plates 3 is formed as shown in FIGS. 2 and 3. A bolt hole 8 for bolting the common fixing plate assembly 12 to the valve housing 2 is provided within the first legs 5 between pairs of adjacent fixing plates 3, as illustrated in FIGS. 2 and 3. The common fixing plate assembly 12 is formed as one piece.

The bolt holes 8 for fixing the first leg 5 of the fixing plate 3 on the valve housing 2 are arranged such that the bolted connection of the fixing plate 3 to the valve housing 2 takes place with a minimal bolt spacing between the central axis 4 of the actuator 1 and the bolts 7, as illustrated with reference to FIG. 1.

Due to the design according to the invention, different clamping forces F are implementable or, given the same clamping force, different stresses acting on the fingers 9 are implementable by varying the spring-loaded length L, namely the length of the second leg 6 between the apex 10 of the fixing plate 3 and the free ends of the fingers 9. For instance, the spring loaded length L may be varied by structurally displacing or moving the apex 10 of the fixing plate 3 perpendicularly to the central axis of the actuator, without changing the position of the actuator 1 or of the bolt holes 8. This is illustrated with reference to FIG. 3. When the fixing plates 3 are configured such that the apexes 10 are further away from the central axis of the actuator than is shown in FIG. 1, the clamping forces acting on the particular actuator 1 are increased. Accordingly, when the fixing plates 3 are configured such that the apexes 10 are further away from the central axis of the actuator than is shown in FIG. 1, with the same clamping forces acting on the particular actuator 1, the stresses acting on the fingers 9 are reducible. Modifications and variations can be made to the embodiments illustrated or described herein without departing from the scope and spirit of the invention as set forth in the appended claims.

### REFERENCE NUMBERS

1 actuator, valve

2 valve housing

3 fixing plate

4 central axis of actuator

5 first leg

6 second leg

7 bolt

8 bolt hole

9 finger

10 apex

11 hydraulic control unit

12 common fixing plate assembly

F clamping force

L spring-loaded length

1-5. (canceled)

6. A device for fixing a directly controlled valve (1) acting as an actuator in a valve housing (2), in a duct plate, or in a transmission housing, the device being fixed to the valve housing (2), the duct plate, or the transmission housing by fixing elements (7), the device comprising:
a fixing plate (3) having a spring-loaded length (L), the spring-loaded length (L) being adjustable independently of a distance of the fixing elements (7) from a central axis (4) of the actuator.

7. The device of claim 6, wherein the fixing plate (3) is bent into a U-shape such that the fixing plate (3) comprises a first leg (5) and a second leg (6),
wherein the first leg (5) is shorter than the second leg (6),
wherein the fixing plate (3) is fixed to the valve housing (2), on the duct plate, or on the transmission housing by fixing the first leg (5) on the valve housing (2), on the duct plate, or on the transmission housing with the fixing elements (7) in a mounted state of the fixing plate (3), the fixing elements (7) being bolts,
wherein the second leg (6) comprises two fingers (9) arranged in parallel to one another,
wherein, with the exception of free ends of the fingers (9), the second leg (6) extends spaced apart from the valve housing (2), from the duct plate, or from the transmission housing and from the actuator (1) in the mounted state of the fixing plate (3),
wherein the free ends of the fingers (9) are bent in the direction of the actuator (1) and introduce a clamping force onto the actuator (1) in the mounted state of the fixing plate (3), and
wherein the spring-loaded length (L) is determined by a length of the second leg (6) defined between an apex (10) of the fixing plate (3) and the free end of the fingers (9).

8. The device of claim 7, wherein bolt holes (8) of the fixing plate (3) for fixing the first leg (5) of the fixing plate (3) on the valve housing (2), on the duct plate, or on the transmission housing are arranged such that a minimum bolt spacing is defined between the central axis (4) of the actuator and the bolts (7).

9. The device of claim 6, wherein the fixing plate (3) is formed as a one-piece sheet-metal component.

10. The device of claim 6, wherein the device is utilized in hydraulic control units (11) for fixing multiple actuators (1) in the valve housing (2) or in the duct plate, the fixing plate (3) being one of a plurality of fixing plates of a common fixing plate assembly (12), wherein a bolt hole (8) for fixing the common fixing plate assembly (12) to the valve housing (2) or to the duct plate is provided between first legs (5) of adjacent fixing plates (3) of the plurality of fixing plates (3).
